(19) United States
(12) Patent Application Publication
(10) Pub. No.: US 2026/0160456 A1
(43) Pub. Date: Jun. 11, 2026

(54) OUTDOOR AIR-TO-AIR HEAT PUMP INSTALLATION WITH THERMALLY INSULATED CONDENSER CHAMBER

(71) Applicant: ZK Varme AS, RYPEFJORD (NO)

(72) Inventor: Thomas Klemmetsen, RYPEFJORD (NO)

(73) Assignee: ZK Varme AS, RYPEFJORD (NO)

(21) Appl. No.: 18/707,065

(22) PCT Filed: Dec. 22, 2022
(86) PCT No.: PCT/NO2022/050327

§ 371 Date: May 2, 2024

(30) Foreign Application Priority Data
Jan. 4, 2022 (NO) 20220009

(51) Int. Cl. F25B 30/02; F24F 1/022; F24F 1/028; F25B 1/00

(52) U.S. Cl. CPC F25B 30/02; F24F 1/022; F24F 1/028; F25B 1/005

(57) ABSTRACT

A heat pump device is for self-installation, wherein the heat pump device has a thermally insulated outdoor condenser chamber for heating an inside air flow led out through a two-part channel in an appropriate opening in an outer wall by means of a fan for heating in a condenser that is installed in a closed heat pump circuit with an appropriate cooling medium, and consisting of a compressor, an evaporator with an as-sociated fan, a condenser and a choke valve, heated air is led back into the building in the second part of the two-part channel and is separated from the intake of the air flow by an interior vent.

### CROSS-REFERENCE TO RELATED APPLICATIONS

This application is the U.S. national stage application of International Application No. PCT/NO 2022/050327, filed Dec. 22, 2022, which international application was published on Jul. 13, 2023, as WO 2023/132751 A1 in the English language. The International Application claims priority to Norwegian Patent Application No. 20220009 , filed Jan. 4, 2022. The international application and Norwegian application are both incorporated herein by reference, in their entirety.

### FIELD

The invention concerns an outdoor heat pump installation and set-up of this, with an out-door-installed condenser unit in a thermally insulated housing/chamber, as well as associated components for leading air out of the building through an existing air vent for heating in a condenser and thereafter hot air in.

### BACKGROUND

A heat pump is a known device consisting of a compressor, a condenser, a reducing valve and an evaporator, which are used for transporting heat energy from a place with lower temperature to a place with higher temperature. This is achieved by compressing an appropriate cooling medium, which is then led through a condenser that cools the cooling medium and gives off heat to the surroundings. The cooling medium condenses and changes to a liquid state. The liquid then streams through a choke valve, which removes the pressure and leads to the boiling point of the cooling medium sinking and the cooling medium thereby evaporating in the evaporator by pulling heat energy from the surroundings. When the cooling medium has evaporated and is in a gaseous state, it enters the compressor in a new cycle. This method typically provides heat energy corresponding to approx. 3 to 5 times the power input.

A disadvantage of known solutions is that the condenser unit must be installed inside the building. This will typically be a big and cumbersome component that must be installed by a cooling installer, who must also carry out pressure testing and gas filling of the system.

### SUMMARY

The purpose of the invention is to remedy or reduce at least one of the disadvantages of prior art, or at least provide a useful alternative to prior art.

The purpose is fulfilled by the features specified in the description below and the subsequent patent claims.

The invention is defined by the independent patent claim. The dependent claims define advantageous embodiments of the invention.

The invention specifically concerns a heat pump device according to claim 1.

The heat pump device itself may use existing, known technology and may be supplied to the customer as a complete unit for easy installation, without the need for a certified cooling installer or electrician. This may be compared to how consumers today purchase appliances like fridges and freezers and install them themselves. The heat pump may be installed in its entirety on the outside of the building, and the air is led through an existing air vent out of the building, through a condenser that heats the air and thereafter into the building through the same air vent, separated in different channels. In an alternative embodiment, air in and out may be led in two different channels.

The invention may be described as comprising four different parts:
a) Interior vent that separates cold and hot air flow
b) Thermally insulated pipe/channel that separates cold air out and hot air in.
c) Transition from an existing external air vent on the building, or a new air vent solution that ensures an airtight and watertight duct.
d) Heat pump unit with a thermally insulated “housing” for a condenser and associated fan and channels for leading the air efficiently through the condenser. The compressor, reducing valve and evaporator are installed in the same unit, but the evaporator and the associated fan may be installed outside the thermally insulated “housing” of the condenser.

This invention is distinct from existing heat pump solutions in that the entire heat pump circuit is installed outside and is supplied as a complete unit. The air from the building is led outside through an existing or new air vent to be heated in the heat pump, and then back inside, preferably through the same air vent. The power supply runs from the inside through the air vent to the outside. Thereby, this solution will fit well in most homes and rooms that are adjacent to an outer wall.

The invention may be regarded as a thermally insulated outside “housing” for the condenser unit of a heat pump, as well as the set-up of this heat pump system with associated components. The purpose of the invention is to reduce the price of the purchase and installation of heat pump solutions. Considering high energy prices, a heat pump is a quick way to reduce heating expenses, as one receives heat energy corresponding to approx. 3-5 times the power input. However, current solutions are expensive and require installation by a certified installer.

The present invention will make heat pump technology available to a larger portion of the population due to a lower purchase price and the ability for the user to install it themselves. It will also simplify installation of heat pumps in rural areas and places where there are no cooling installers available. The invention is based upon existing heat pump technology, wherein cooling medium in a liquid phase and low pressure that pass through an evaporator and absorb energy from the surroundings so that the liquid transitions to a gaseous state. Thereafter, the gas is pressurised in a compressor before it passes through a condenser wherein the gas is condensed to liquid and gives off heat. Down-stream of the condenser, the liquid passes through a valve that reduces the pressure, before the process starts over again. The heat pump technology will not be described in more detail herein, as its theory is presumed to be known.

According to the invention, an outside, thermally insulated condenser chamber is used, as well as the simplified installation of the heat pump system. With this invention, heat pump technology will become available to more people and in places where it may be difficult to find installers of standard heat pumps, and it will be financially advantageous to install it even in smaller rooms as the price will be significantly lower than what is available on the market.

Since the heat pump unit is provided as a complete system for installation on the outside of a building, the need for gas will also be less due to shorter distances between the components compared to a traditional heat pump solution, where the condenser is installed on the inside and the evaporator is installed on the outside. The condensation water from the heat exchanger is drained out at low points on the unit.

By using an existing vent in the outer wall, it will not be necessary to cut a whole in the wall to install the heat pump. The outside vent may be either adapted by cutting the sheet metal to size and installing a transition, or replaced in its entirety with the provided vent solution. This ensures an airtight and watertight duct.

Power may be acquired from inside via a cord that passes through the vents/the hole in the outer wall and out to the compressor and the fan. The power cord is provided complete with a plug for plugging into an existing outlet.

Another advantage is that less space is required inside, as the new vent that leads the cold and the hot air flow away from each other, is small in dimensions compared to current interior solutions for heat pumps.

In summary, this will result in a significantly lower cost for households when acquiring a heat pump. In a normal detached house, it may be an option to install several of these heat pump units for better heat distribution in the building. This new unit may replace most panel heaters that are installed in a room that is adjacent to an outer wall and has an air vent, and it will be very relevant for studio flats and smaller flats where installing a traditional heat pump solution previously has not been economically justifiable.

### BRIEF DESCRIPTION OF THE DRAWINGS

In the following, an example is described of a preferred embodiment, which is illustrated in the attached drawings, wherein:

FIG. 1. schematically shows a heat pump system according to the present invention, and

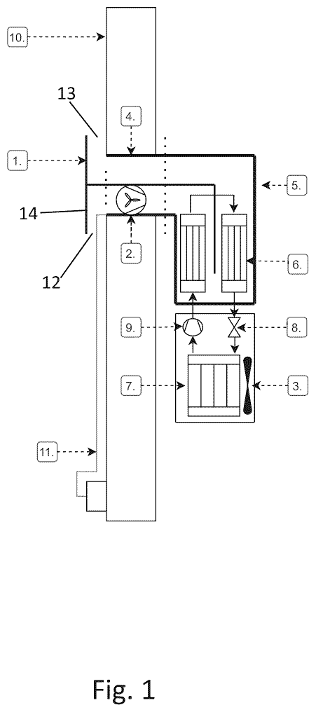

FIGS. 2A and 2B show, seen in perspective from the front and the back respectively, an interior vent as used in a heat pump system according to the invention.

### DETAILED DESCRIPTION OF THE DRAWINGS

The heat pump system comprises a circuit for the air and a separate circuit for the cooling medium, which will be described in the following.

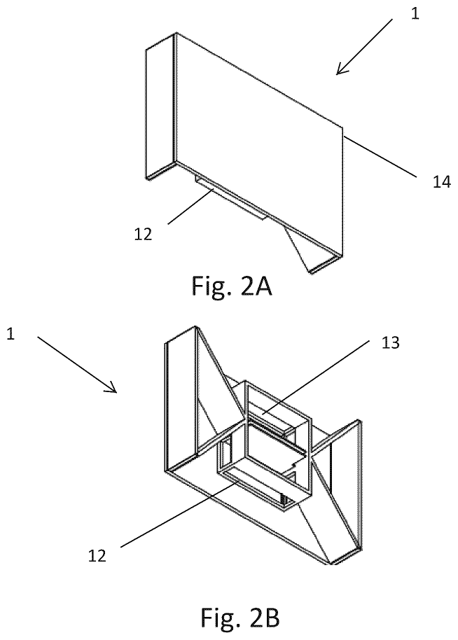

The circuit of the air is explained in this section. Cold air is pulled into the bottom part of an interior vent 1 and is blown out to a condenser chamber 5 by means of a fan 2 through a bottom half of an insulated channel 4 into the condenser chamber 5. The air is then led through a condenser 6, is heated and is led back in a top part of the channel 4 to a top part of the interior vent 1 and is blown into the room. The interior vent is designed to separate hot and cold air flows. The interior vent is preferably designed to have the lowest pressure loss possible, and the cross-section anywhere in the vent should not be less than the cross-section of the air channel 4 that leads the air into the condenser chamber 5 and back. The advantage of such an interior vent 1 compared to a standard, split air-to-air heat pump is that the interior vent 1 neither includes fan 2 nor condenser 6, and may thereby be designed to be very compact. In the embodiment shown, the vent 1 is designed with a cover 14 that lies against the interior side of the outer wall 10. Openings on the bottom side and top side respectively form inlets 12 and outlets 13. In an advantageous embodiment, the interior vent 1 may have dust/particle filters on the inlet 12 of the air as well as dampers (not shown) for adjusting the air flow out of the vent 1, as shown in FIG. 2B.

A cooling medium with high pressure and high temperature flows out of a compressor 9, into the condenser 6 and is then cooled by the air flow in the condenser chamber 5 so that the cooling medium gives off energy, condenses and transitions to a liquid phase. Thereafter the cooling medium runs through a reducing valve 8, which reduces the pressure in the cold cooling medium, before it enters an evaporator 7 wherein outside air with a higher temperature than the cooling medium heats the cooling medium so that the liquid evaporates to gas. A fan 3 drives the outside air over the evaporator 7. The gas that leaves the evaporator 7 then enters the compressor 9 and the circuit starts over again. In the embodiment shown, a power cord 11 has been lain from the heat pump device and through the bottom part of the two-part channel 4 to an inside socket. In other embodiments, the power cord may be lain through the top channel, other ducts in the outer wall or to an outside socket.

The invention works by the fan 2 blowing cold air out of the building and into the thermally insulated condenser chamber 5, wherein the condenser unit 6 associated with a heat pump circuit consisting of the compressor 9, the condenser 6, the reducing valve 8 and the evaporator 7, is installed. The air is heated as it passes through the condenser 6, and heated air is led back into the building.

The heat pump circuit must also be filled with an appropriate cooling medium adapted to the working temperature of the unit. In some embodiments, the cooling medium may be of the type R290 (propane) or R32 (difluoromethane).

The vent unit 1 is on the inside designed to lead the hot air in a direction different from the intake of the cold air.

The pipe section/the channel 4 that is installed in the hole in the outer wall 10 is designed so that hot and cold air is kept separate with minimal heat transfer from the hot air to the cold air. The pipe section/the channel 4 is adapted to fit the standard measurements of air vents, but may also be provided with other dimensions adapted to new holes. In some embodiments, the two-part channel 4 and/or the condenser chamber 5 may be insulated by vacuum cell insulation (approx. 0.007 W/(m*K)), Armaflex®, 0.033 W/(m*K), polystyrene (styrofoam) 0.026-0.04 W/(m*K) or other suitable materials with corresponding insulating qualities.

In the pipe section 4 or the condenser chamber 5, a fan 2 will be installed that will provide the air circulation through the condenser chamber 5.

The condenser chamber 5 is insulated to minimise heat loss to the surroundings and is predominantly made of a material that minimises the need for maintenance. The condenser chamber 5 is of a design and size that ensures good heat transfer from the condenser to the air and leads the hot air efficiently back to the building. The compressor 9 may be installed in or outside the condenser chamber 5. When installed in the chamber 5, heat loss from the compressor to the surroundings may be eliminated, however installation outside may be appropriate due to noise.

The remaining components in the heat pump circuit may be installed both to the side of or above/below the condenser chamber 5. However, it will be necessary for them to be pre-installed on the same unit as the condenser chamber 5 to avoid having to fill cooling medium and to avoid damage to pipes and equipment during installation. It may be relevant to produce the heat pump in both embodiments so that it fits different building façades.

It may be relevant to run the heat pump circuit in reverse to achieve cooling of the building on hot days.

1. A heat pump device for self-installation, wherein the heat pump device comprises:
a thermally insulated outdoor condenser chamber with a condenser for heating an inside air flow led out through a two-part channel in an appropriate opening/openings in an outer wall by a fan, wherein the condenser is installed in a closed heat pump circuit with an appropriate cooling medium, wherein the closed heat pump circuit further comprises a compressor, an evaporator with an associated fan, a condenser and a choke valve, heated air is led back into a building in a second part of the two-part channel and is separated from the intake of the air flow by an interior vent.

2. The heat pump device according to claim 1, wherein the two-part channel is thermally insulated and designed for low heat transfer between cold and hot air flows.

3. The heat pump device according to claim 1, wherein the interior vent is designed to separate cold and hot air flows.

4. The heat pump device according to claim 1, wherein the compressor is installed in the condenser chamber.

5. The heat pump device according to claim 1, wherein the compressor is installed outside the condenser chamber.

6. The heat pump device according to claim 2, wherein the interior vent is designed to separate cold and hot air flows.

7. The heat pump device according to claim 2, wherein the compressor is installed in the condenser chamber.

8. The heat pump device according to claim 3, wherein the compressor is installed in the condenser chamber.

9. The heat pump device according to claim 2, wherein the compressor is installed outside the condenser chamber.

10. The heat pump device according to claim 3, wherein the compressor is installed outside the condenser chamber.
